(19) United States
(12) Patent Application Publication
(10) Pub. No.: US 2002/0030389 A1
(43) Pub. Date: Mar. 14, 2002

(54) Reclining and inclining chair

(76) Inventor: Troy-Moses K. Panton, Brooklyn, NY (US)

Correspondence Address: BRIAN ROFFE, ESQ, 366 LONGACRE AVENUE, WOODMERE, NY, 11598

(21) Appl. No.: 09/921,783

(22) Filed: Aug. 3, 2001

Related U.S. Application Data
(60) Provisional application No. 60/223,241, filed on Aug. 4, 2000.

(51) Int. Cl. A61G 15/00

(52) U.S. Cl. 297/68

(57) ABSTRACT

Chair including a base, a seat structure supported on the base, a footrest structure pivotally connected to the seat structure, a backrest structure pivotally connected at a lower end to the seat structure, and a transfer structure pivotally connected at a front end to the footrest structure and pivotally connected at a rear end to the backrest structure. The footrest structure, backrest structure and transfer structure are so designed that when the footrest structure pivots toward a horizontal position, the transfer structure moves rearward and causes the backrest structure to pivot toward a horizontal position, without movement of the seat structure, and vice versa. Further, the elements are so designed that when the footrest structure pivots toward a vertical position, the transfer structure moves forward and causes the backrest structure to pivot toward a vertical position, without movement of the seat structure, and vice versa.

### CROSS-REFERENCE TO RELATED APPLICATION

This applications claims priority under 35 U.S.C. §119(e) of U.S. provisional patent application Ser. No. 60/223,241 filed Aug. 4, 2000.

### FIELD OF THE INVENTION

The present invention relates to a chair which reclines and inclines while providing the occupant with a smooth transition from the inclined position to a relaxed or reclined position and vice versa.

The present invention also relates to a base for a chair which compensates for unevenness of the surface on which the chair is placed.

### BACKGROUND OF THE INVENTION

Numerous patents disclose a conventional recliner arrangement in which the footrest is in a retracted position when the chair in the upright position and is extended when the chair is in the reclining position. The footrest is not used in the transition from the upright position to the reclining position. For example, U.S. Pat. No. 4,212,495 (Gall), U.S. Pat. No. 4,357,049 (Rogers, Jr. et al.), U.S. Pat. No. 4,423,903 (Gerth), U.S. Pat. No. 4,506,925 (Crum), U.S. Pat. No. 4,519,647 (Rogers, Jr. et al.) and U.S. Pat. No. 4,531,778 (Rogers, Jr. et al.) all show footrests linked to the seat and/or backrest and which are extended manually (by pressing a lever) or by leaning against the backrest.

Also in this connection, U.S. Pat. No. 6,030,033 (Schultz) shows a chair including a footrest which is pivoted from a passive parking position to an extended position upon movement of the seat rearward relative to the frame of the chair while U.S. Pat. No. 5,246,266 (Ostergaard) shows a chair in which the angle between the footrest and the seat varies with the displacement of the seat. That is, by moving the seat, the footrest swings out and back.

U.S. Pat. No. 4,752,100 (Lemaire) shows a linkage between the footrest and backrest. The footrest 5 is linked to a triangle linkage 20 via crosspieces 41 and 26 so that the footrest is tiltable either separately from or simultaneously with the tilting of the seat 3 and backrest 1.

Further, mention is made of U.S. Pat. No. 4,479,679 (Fries et al.), U.S. Pat. No. 5,335,972 (Jensen) and U.S. Pat. No. 5,486,035 (Koepke et al.) Jensen shows a chair having a backrest 14, a seat 16 and a footrest 18. The occupant moves between an upright position and a reclining position by shifting his or her weight so that there is a “smooth transition” between the two positions. Fries et al. shows a chair in which the occupant's body weight serves as the primary source for reclining the chair and returning the chair to an upright position. Koepke et al. shows a chair in which the occupant's weight is used to change the configuration of the chair (compare FIG. 1 to FIG. 4).

There are also several different types of chairs in the prior art which have a footrest continually extended. For example, chair for invalids often have a footrest that is integral with the seat to facilitate sitting down and rising (see U.S. Pat. No. 4,059,305 (Ammirata)). Also, dental chairs usually include an integral footrest, the movement of which is linked with the movement of the backrest (see U.S. Pat. No. 3,934,929 (Rabinowitz)).

### OBJECTS OF THE INVENTION

It is an object of the present invention to provide a new and improved chair which both reclines and inclines.

It is another object of the present invention to provide a new and improved chair which reclines and inclines without requiring the use of latches, levers, locking systems, motors, springs or any hydraulic systems.

It is yet another object of the present invention to provide a new and improved chair which reclines and inclines while providing the occupant with a smooth transition from the inclined position to a relaxed or reclined position and vice versa.

It is still another object of the present invention to provide a new and improved chair which enables an occupant to recline and incline the chair by applying a force on a footrest and/or backrest to control a desired angle of reclining or inclining while keeping the feet and back at all times in equilibrium.

It is yet another object of the present invention to provide a new and improved base for a chair which enables the chair to have some flexibility.

It is still another object of the present invention to provide a new and improved base for a chair which flexes to compensate for unevenness in the floor.

It is still another object of the present invention to provide a new and improved sitting surface and backrest surface for a chair.

### SUMMARY OF THE INVENTION

In order to achieve one or more of the objects set forth above, a chair in accordance with a first embodiment of the invention comprises a base, a seat structure supported on the base, a footrest structure pivotally connected to the seat structure, a backrest structure pivotally connected at a lower end to the seat structure, and a transfer structure pivotally connected at a front end to the footrest structure and pivotally connected at a rear end to the backrest structure. The footrest structure, backrest structure and transfer structure are so designed that when the footrest structure pivots toward a horizontal position, the transfer structure moves rearward and causes the backrest structure to pivot toward a horizontal position, without movement of the seat structure, and vice versa. Further, the elements are so designed that when the footrest structure pivots toward a vertical position, the transfer structure moves forward and causes the backrest structure to pivot toward a vertical position, without movement of the seat structure, and vice versa.

More particularly, to achieve this operation, in a preferred embodiment, the transfer structure is independently movable relative to the seat structure such that movement of the transfer structure does not result in movement of the seat structure in a horizontal plane. The seat structure can also be fixed to the base to prevent movement of the seat structure in a horizontal plane, specifically, movement which might arise during pivoting of the footrest structure or backrest structure as is typical in conventional reclining chairs.

The seat structure may comprise a rigid support and a flange extending from the support, the flange being pivotally connected to the backrest structure. A pivot pin may be used to connect the flange and backrest structure for pivotally connecting the backrest structure to the seat structure. The rigid support can extend along at least a portion of a periphery of the seat structure and material provided between opposed sides of the support to define a sitting surface of the seat structure.

The footrest structure may comprise a substantially U-shaped member having first and second ends. Pivot pins may be used to connect the first and second ends of the U-shaped member of the footrest structure to the seat structure. The footrest structure can also include an elongate extension fixedly connected to each end of the U-shaped member, the extensions being pivotally connected to the front end of the transfer structure. To this end, pivot pins may be used for connecting the extensions to the front end of the transfer structure.

The backrest structure may comprise a rigid support along at least a portion of a periphery of the backrest structure and discrete sections of material situated between opposed sides of the support and defining a support surface of the backrest structure. The discrete sections of material can be sized, shaped and/or positioned to provide a contour for the person's back.

The transfer structure may comprise a connecting member pivotally connected to the backrest structure and first and second arcuate member each pivotally connected at a forward end to the footrest structure and fixedly connected to the connecting member at a rearward end. The backrest structure can also include a flange mounted on a back side, the connecting member being pivotally connected to the flange.

The base may be any base which supports the seat structure while providing stability during the reclining and inclining activities of the chair. One particular construction of a base for use in a chair in accordance with the invention comprises a seat support structure connected to the seat and a plurality of tensioned legs each connected to the seat support structure whereby the legs flex upon vertical movement of the seat structure. The tensioned legs may comprise arched members each connected at a first end to the seat support structure and tension rods each connected at a first end to the seat support structure and at a second end to a second end of a respective one of the arched members. This particular base may be used in other chairs.

Another embodiment of a chair in accordance with the invention comprises a seat structure, a base for supporting the seat structure without allowing movement in a horizontal plane, a footrest structure pivotally connected to the seat structure such that a first pivot point is defined between the footrest structure and the seat structure, a backrest structure pivotally connected at a lower end to the seat structure such that a second pivot point is defined between the backrest structure and the seat structure and s transfer structure pivotally connected at a front end to the footrest structure such that a third pivot point is defined between the transfer structure and the footrest structure and pivotally connected at a rear end to the backrest structure such that a fourth pivot point is defined between the transfer structure and the backrest structure. The first, second, third and fourth pivot point form a trapezoid which elongates upon reclining of the chair.

The chair in accordance with the invention was invented not for the reason of the conventional reclining chair. Its purpose is not to recline to a nearly horizontal position. It is more of a sitting chair than it is a reclining chair. The reclining system can more be classified as a flexing system, which is inspired by the nature of a human being. In many cases when a human sits for a long period of time on a rigid or static upright chair, he/she has the tendency to put the feet forward in a more inclined position and to push the pelvis forward to place the body into a reclined position. What this does; however, is to hurt the tailbone of the occupant, considering that only a small amount of surface of the buttocks is being sat on. The spine is inadequately supported, considering the whole back of the occupant is only being supported by the shoulder blades, leaving the spine to suspend and stretch. The maximum surfaces of the seat and back are not being used, and a static upright chair does not work for long term sitting.

The chair in accordance with the invention addresses this problem by allowing the occupant to recline to his/her desired ratio of an inclined footrest and a reclined backrest. The occupant may recline to the maximum point of recline, or incline to an upright position, or recline to any point in between the upright position and the reclined position, always being in equilibrium, considering the feet of the occupant are always on the footrest as he/she leans on the backrest.

This is achieved by a simple mechanism of four points, located to form a trapezoid that when elongated creates the reclining system described above. Both the backrest and the footrest have two points. The backrest and the seat are connected at one pivoted joint. The first point of the footrest is connected to the front of the seat. The second point of the footrest connects to a member supporting the armrest; this member then connects to the second point of the back. b With these four points, the occupant of the chair may recline at his/her own comfort.

The proportions and dimensions of the chair are critical in allowing the chair to perform, considering that; the right weight should be on the footrest to adequately balance the reclining mechanism. If an occupant's legs are not long enough to reach the footrest, then the performance will be somewhat different. In this case, the length of the footrest will have to be specified. The proportions shown here and dimensions are according to that of the inventor.

### BRIEF DESCRIPTION OF THE DRAWINGS

For a more complete understanding of the present invention, reference is made to the following detailed description and accompanying drawings. In the drawings, like reference characters refer to like parts throughout the several views, in which:

FIG. 1 is a side elevation showing the chair in the upright position;

FIG. 2 is a side elevation showing the chair in a partially recumbent position, the angle shown here ranges from upright to the fully reclined position;

FIG. 3 is a side elevation showing the chair in its fully recumbent position;

FIG. 4 shows a front elevation, joints 4a and 4b are synonymous, as well as joints 6a and 6b;

FIG. 5 shows a back elevation; and

FIG. 6 is a top view showing the sitting and back surfaces.

### DETAILED DESCRIPTION OF PREFERRED EMBODIMENTS

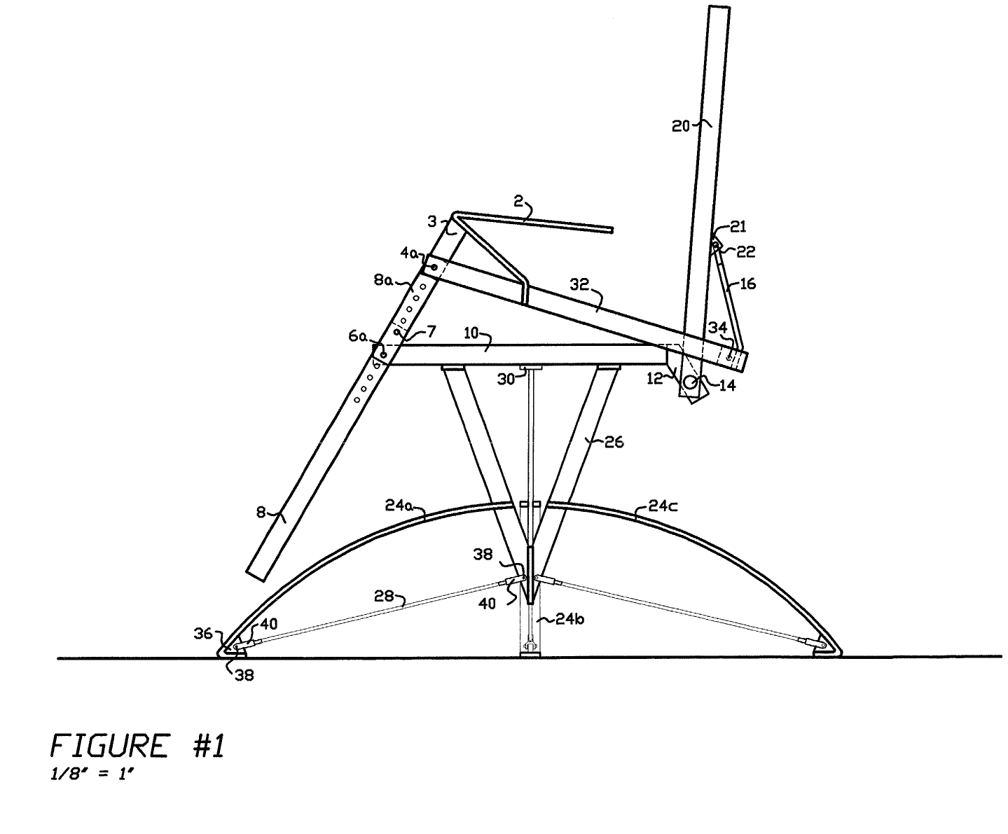

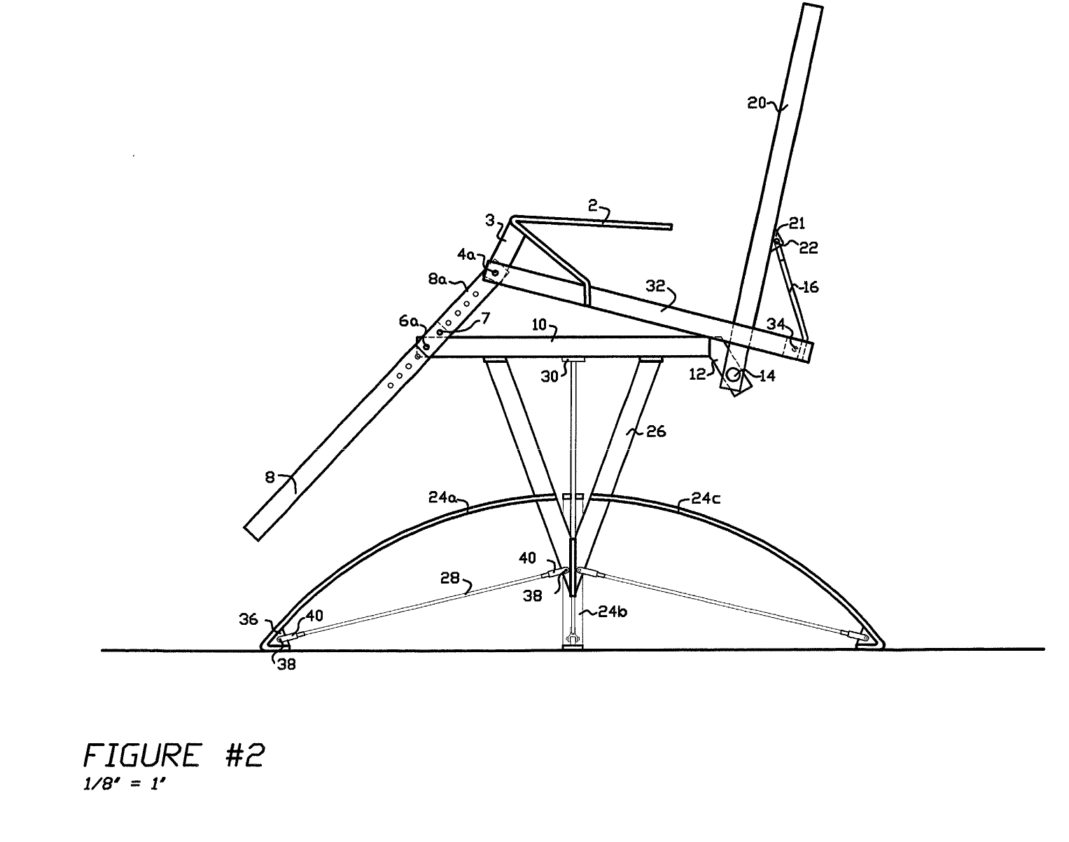

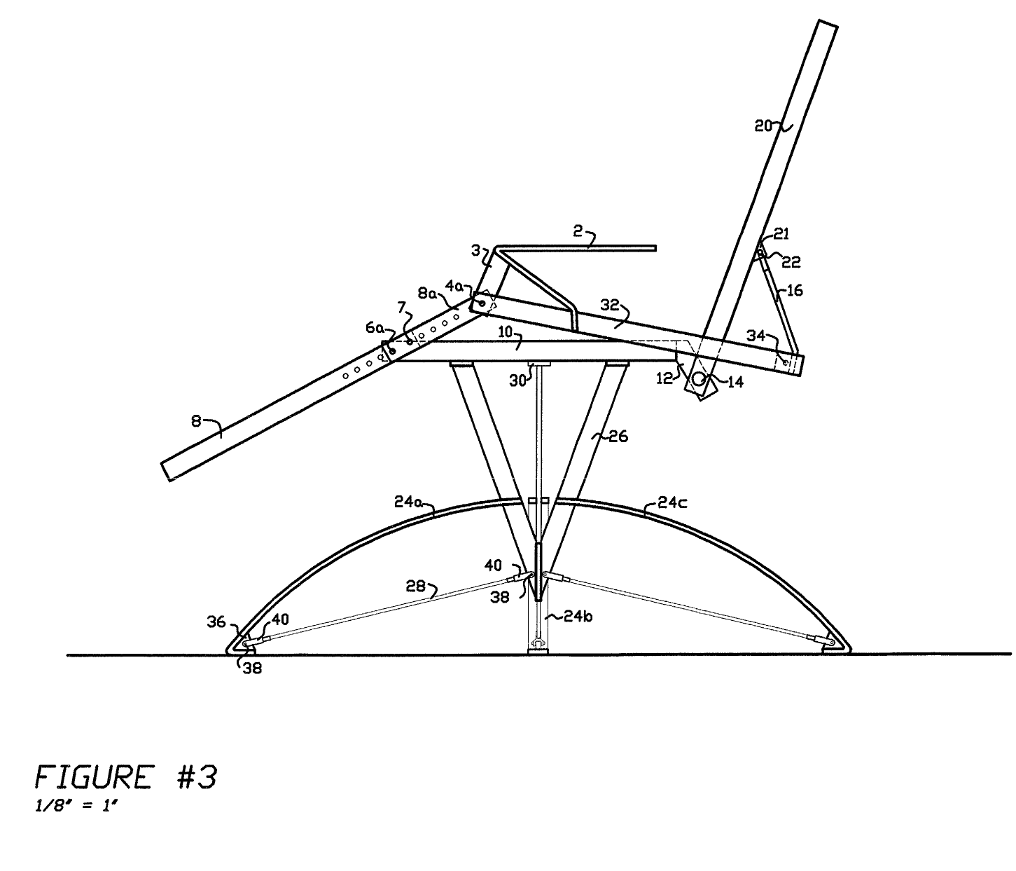

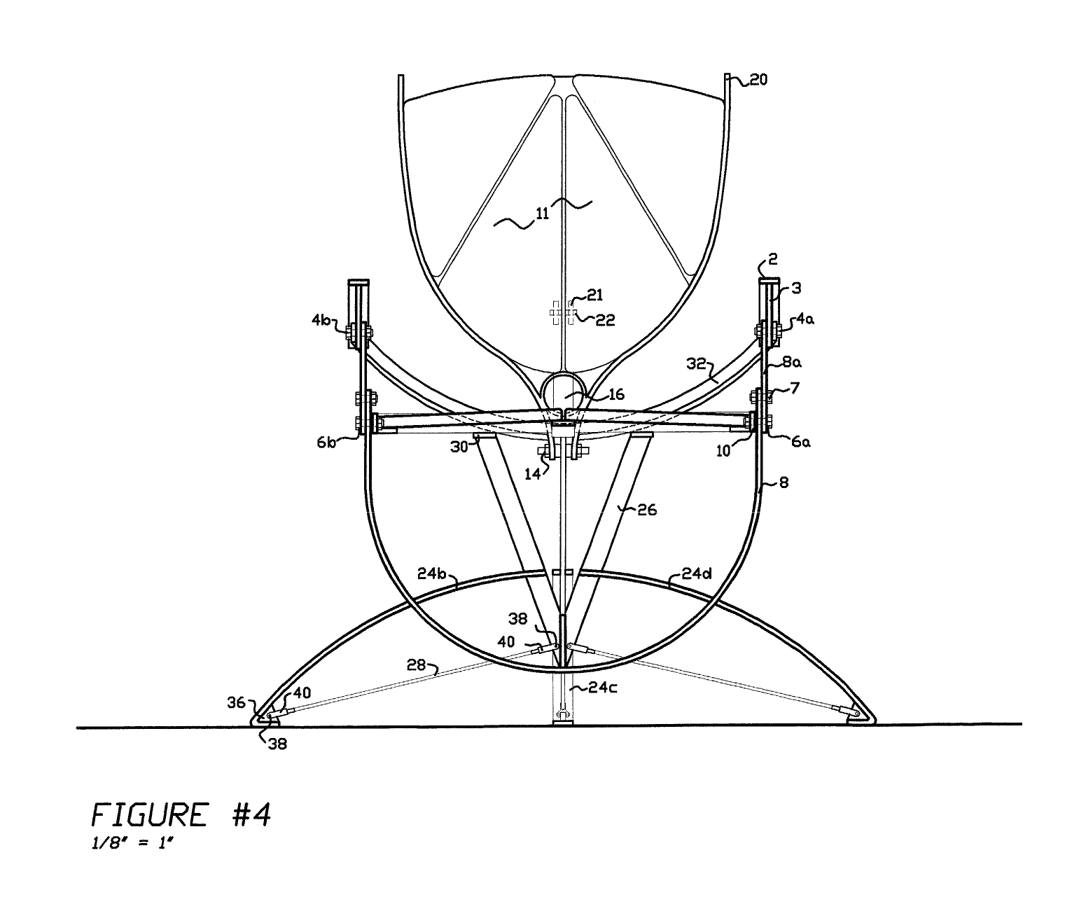

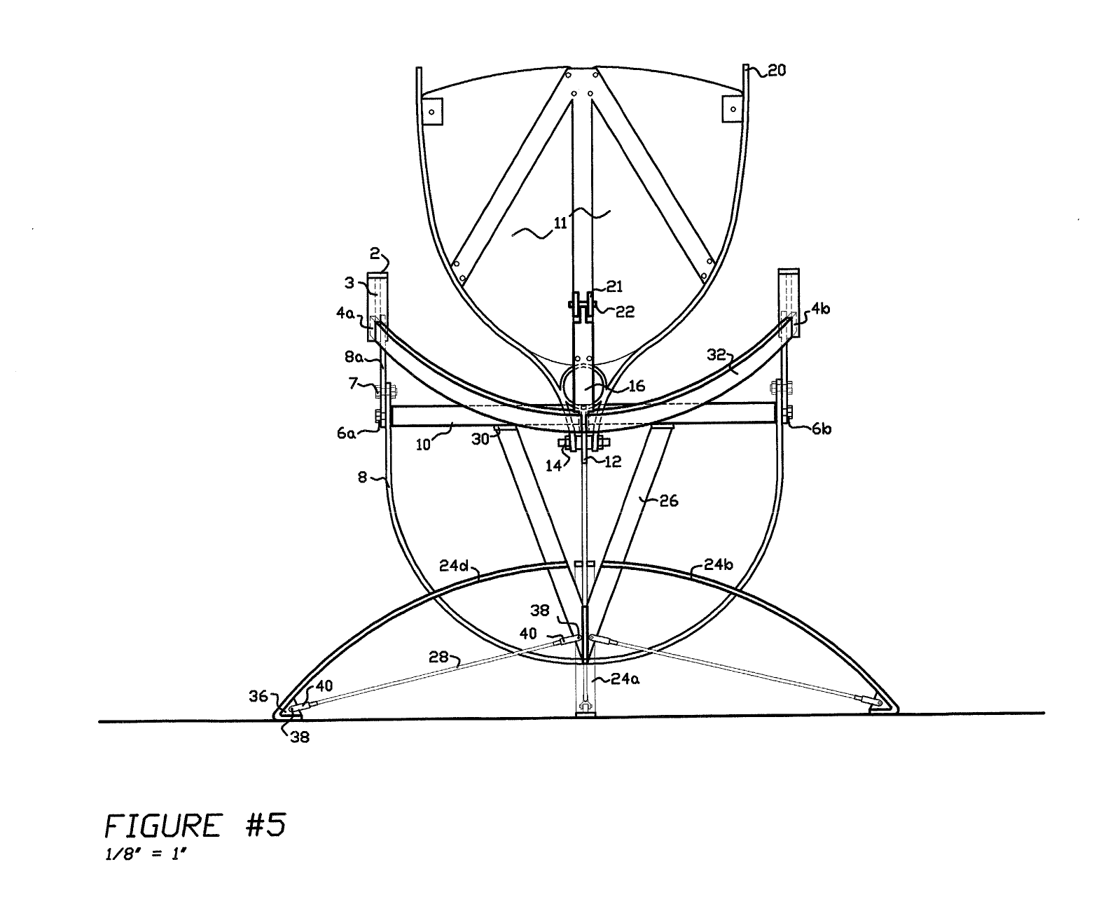

Referring now to FIGS. 1-6 wherein the same reference numerals refer to the same or similar elements, FIGS. 1, 2 and 3 show in side elevation the reclining mechanism in action. Pivot joints 4a, 6a, 14 and 22 are most critical and form the trapezoid as discussed herein. Joints 4a and 4b, and joints 6a and 6b, are on the right and left sides of the chair, as seen in FIGS. 4 and 5. Therefore, there are actually six joints that rotate, but an arrangement of four points that create the reclining system, as seen in FIGS. 1, 2, and 3 (since joints 4a and 4b and 6a and 6b are actually in the same location when the chair is viewed from its side as shown in FIGS. 1-3).

To begin the reclining movement of the chair, the occupant must first release his/her foot weight from a substantially U-shaped footrest 8 and simultaneously apply back pressure to the backrest 20. Member 8a is an extension of footrest 8, consider them one piece which will be referred to herein as a footrest structure. The footrest 8 pivots at joint 6a, which is defined by a pivot pin, at the front of seat 10 to perform the recline/incline movement described above. Joint 4a, which is the end of the radius of the footrest 8 and is defined by a pivot pin, reacts to the clockwise rotation of the footrest 8, and thrusts members 32 backward. Members 32 are linked to member 16 via connection 34, which makes a rigid connection with members 32 and 16. The combination of member 16 and members 32 is referred to herein as a transfer structure. Because members 32 and 16 both move backward upon pivoting of the footrest structure upward to a horizontal position, this action causes the backrest 20 to follow the same path as member 16 which is joined to the backrest 20 via flange 21 at pivot joint 22, which may be defined by a pivot pin. The combination of the backrest 20 and flange 21 is referred to herein as the backrest structure. The backrest 20 is connected to the seat 10 via flange 12 at pivot joint 14. Flange 12 is a welded connection with seat 10, with the combination of the seat 10 and flange 12 being referred to as the seat structure herein. This simple trapezoidal arrangement of joints 4a, 6a, 14 and 22 is what puts the chair in a balanced movement. The footrest 8, seat 10, backrest 20, and members 32 and 16 are integral. These elements put the chair in motion.

As shown, the transfer structure includes a pair of arcuate members 32 and an elongate member 16 connected at a lower end to a rearward end of the members 32 and at an upper end to the pivot joint 22. This construction is exemplary only and is not intended to be limiting.

The seat 10, and flange 12, do not move during the pivoting movement of the footrest 8, the forward/backward movement of the members 16,32 or the pivoting movement of the backrest 20. Rather, the seat structure is maintained in its position in the horizontal plane. This is in contrast to conventional reclining chairs in which the seat moves in conjunction with the pivoting of the footrest and/or backrest.

Although pivot pins are described as being used for connecting various members together, i.e., those which pivot with respect to one another, other means for pivotally or rotatably connecting the various members could also be used in the invention without deviating from the scope and spirit thereof.

The armrest 2 and member 3 are fixed to one another, e.g., welded together. The armrest 2 is also very important and useful in the reclining action, as it adds comfort to the occupant of the chair. The armrest 2 follows the path of member 32 and is connected to member 32 and footrest extension 8a via member 3 at point 4a. The armrest 2 therefore follows the occupant's arms as the occupant either reclines or inclines. Thus, joint 4a is the junction of three elements: footrest extension 8a, members 3 and 32.

The maximum reclined position is not stopped by any locking system. Because the arrangement of joints is trapezoidal, there is a natural limit at which the trapezoid formation may be elongated, unlike a parallelogram which is able to lay flat when elongated. The maximum upright position is attained when the occupant sits up in a natural manner by releasing his/her back weight from the backrest 20, and applying pressure to the footrest 8. The footrest 8 is stopped by the front leg 24a.

When dismounting the chair, it is necessary that the occupant use the footrest 8 as a step to step down, as he/she braces on the armrest 2 to get up. If too much weight is applied to the armrest 2 without standing on the footrest 8, the chair will move to a reclined position because the angle between footrest extension 8a and member 32 at joint 4a will be greater. Everything is in balance. When mounting the chair, it is also necessary to first step on the footrest.

A stable and broad base is necessary to support the chair. Because the chair reclines, leverage is usually necessary to prevent the chair from toppling over. Thus, a special base was designed for this matter. Furniture that has four legs usually only stand on three of the four legs when on an uneven surface. The fourth leg is for balance; thus, the furniture will topple to the fourth leg in the event that weight is being applied to that side. The base of the chair addresses this problem by flexing. This flexing of the base compensates for unevenness in the floor on which it sits. Thus, all four legs are always on the floor to prevent instability when the chair reclines/inclines and the weight is shifted. Tests show that up to half-inch unevenness in floor levels within a two-foot radius will be compensated for with this base.

In the illustrated embodiment, the base is four feet wide, and four feet deep. It is composed of four arched legs 24a, 24b, 24c and 24d (see FIGS. 4 and 5), a seat support structure 26 supporting the seat 10, and four tension rods 28 corresponding to each leg 24. Structure 26 is preferably made of four braces or members fixed together, e.g., by welding, at one converging point, and splayed out to support the seat 10. Tabs 30 are welded to each splayed member of structure 26. Structure 26 is connected to seat 10 via bolts at tabs 30, although other means for connecting the braces of structure 26 to the bottom of the seat 10 may also be used in accordance with the invention. Tension rods 28 include two yokes 40 at each end. Each leg 24 is welded to structure 26. Because the legs are arched and span such a wide distance, they have the tendency of splaying. Tension rods 28 tie each leg 24 to the converging point of structure 26. This creates a bow that flexes. All the legs 24 are identical. The bottom ends of each tension rod 28 connect to the end of each leg 24 via webs 36, which are nestled in, and welded to the inward-bent feet of legs 24. The yokes 40 are then secured by pins 38. The top ends of tension rods 28 are connected to structure 26 with yokes 40 and pins 38.

The proportions and dimensions are important in allowing the occupant to be comfortable and for the machine to work properly. The dimensions shown here are according to that of the inventor. Generally though, each construction of the chair is specific to its user concerning necessary dimensions in allowing it to reach its optimum performance. If a user is too short or too tall, the highest performance will not be reached, although satisfactory performance would likely be obtained. The dimensions and proportions of the illustrated embodiment are suited comfortably for any user 3″ shorter or 4″ taller than the purposed designed height (6′1″). Having such dimensions, the act of reclining/inclining can thus be controlled optimally by the occupant.

To determine the optimum dimensions of the chair for a particular person, the distance between the person's heel and back of the knee is measured and the distance between the back of the knee and the tailbone is measured. Using these two dimensions, the size of the seat 10 is determined to enable the person's knees to be forward of the front edge of the seat 10 and the footrest 8 is adjusted so that the person's feet are able to be in contact with the footrest 8. Adjustment of the footrest 8 is enabled by the provision of holes in the upper ends of the footrest 8 and holes in extension 8a. From a production standpoint, it is conceivable that several chairs can be produced, each adaptable for a people within a morphological range, i.e., within a height range and a range of different measurements of the distance between the heel and back of the knee and tailbone and back of the knee. As such, a person would need to know these measurements and then be able to purchase a chair optimally suited for them, with only the possible need to adjust the footrest 8.

It is necessary for the occupant's feet to be adequately resting on the footrest to create a weight that adequately counterbalances the back weight. Therefore, the footrest is adjustable up to five inches by appropriate provision of holes in the footrest 8 and extension 8a.

Member 32 supporting the armrest 2 can also be lowered, allowing the chair to be scaled to a smaller occupant. The footrest 8 is connected to member 8a which is an extension of the footrest 8, along which all adjustments take place. To make adjustments, it is necessary to simply align the holes of the footrest 8 and extension 8a at the desirable points beginning at pivot joint 6a, and then fasten with bolt 7 at any other two aligned holes; making footrest 8 and extension 8a one piece.

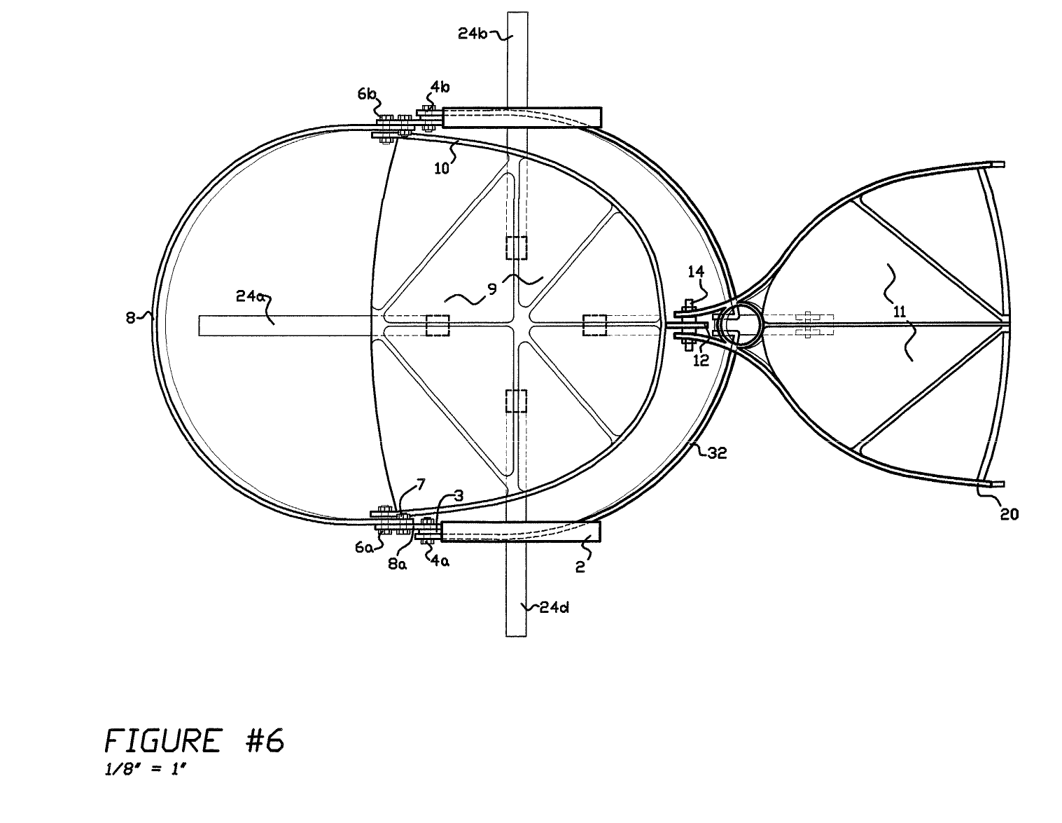

The seat and back surfaces 9 and 11 can range from wood to cushioned upholstery and in a preferred embodiment comprise discrete sections of material sized, shaped and/or positioned to provide a comfortable support surface (see FIGS. 4 and 6).

More particularly, the seat and back surfaces 9 and 11 are made, in combination, of twelve substantially triangular tiles situated in a pattern to provide the occupant with a comfortable seat. The tiles slope gently but noticeably. The four-tile arrangement of the back surface 11 creates contouring for the occupant, and is substantially symmetrical with respect to a vertical center line. The tiles are separated where the surfaces of the back change. These triangular back tiles are cut as to create a conical surface, cradling the occupant. The seat surface 9 like the back surface 11 is made of triangular tiles (eight in this case), specifically cut to create a comfortable seat by contouring the surface slightly, and are also substantially symmetrical with respect to a center line. Neither the seat 9 nor back surfaces 11 are flat, but the tiles that compose them are. The seat is deep as to create a large sitting surface; supporting a portion of the occupant's legs and buttocks, and not just the buttocks alone. This allows for the occupant to sit for a longer period of time without discomfort. It is not what you sit on, it is how you sit on it.

To support the tiles forming the back surface 11, rigid support members are attached to the peripheral support. As shown most clearly in FIG. 5, these support members include two rectangular supports arranged proximate the upper ends of the peripheral support and an arrow-shaped support having three elongate portions. The circles in FIG. 5 represent points of attachment of the tiles to the support members, e.g., by screws or nails or the like, with each tile being attached at its or proximate its three corners to support members. In this manner, the support members hold the tiles to thereby enable the tiles to form the back surface 11.

In a similar manner, the seat 10 includes one or rigid support members to which the tiles forming the seat surface 9 are attached. Thus, as can be seen from FIG. 6, between each tile, a support member is present. The tabs 30 are connected to the support member(s) as can be seen from FIG. 6.

Thus, among the inventions disclosed above is a reclining and inclining chair that includes a seat, a backrest, a footrest, armrests and a base. A linkage may connect the rear side of the backrest, the armrests and the footrest to enable the occupant to recline in equilibrium when the occupant's feet are on the footrest and back leans against the backrest. That is, the footrest is not retracted below the seat as in conventional recliners but rather, the occupant's feet rest on the footrest and are used in combination with the pressure applied by the occupant leaning against the backrest to move the chair between its maximum reclined position and upright position.

The base may be constructed of four interconnected legs, each leg including a brace extending downward from the bottom of the seat and an arcuate rod. The lower ends of the braces may be connected to one another while the upper ends of the braces are spread out across the seat to provide support for the occupant. Each rod extends from a middle portion of a leg outward. The base may also include tensioned strings extending between the lower end of each brace and the respective outward end of a rod. The base thus flexes to compensate for unevenness in the floor.

Also disclosed are seat support and resting surfaces comprising a plurality of planar, triangular tiles or pieces of material arranged to provide a contour for the chair's occupant.

While the invention has been illustrated and described in detail in the drawings and the foregoing description, the same is to be considered as illustrative and not restrictive in character, it being understood that only the preferred embodiments have been shown and described and that all changes and modifications that come within the spirit of the invention are desired to be protected.

I claim:

1. A chair comprising:
a base;
a seat structure supported on said base;
a footrest structure pivotally connected to said seat structure;
a backrest structure pivotally connected at a lower end to said seat structure; and
a transfer structure pivotally connected at a front end to said footrest structure and pivotally connected at a rear end to said backrest structure;
whereby,
when said footrest structure pivots toward a horizontal position, said transfer structure moves rearward and causes said backrest structure to pivot toward a horizontal position without movement of said seat structure,
when said backrest structure pivots toward a horizontal position, said transfer structure moves rearward and causes said footrest structure to pivot toward a horizontal position without movement of said seat structure,
when said footrest structure pivots toward a vertical position, said transfer structure moves forward and causes said backrest structure to pivot toward a vertical position without movement of said seat structure, and
when said backrest structure pivots toward a vertical position, said transfer structure moves forward and causes said footrest structure to pivot toward a vertical position without movement of said seat structure.

2. The chair of claim 1, wherein said transfer structure is independently movable relative to said seat structure such that movement of said transfer structure does not result in movement of said seat structure in a horizontal plane.

3. The chair of claim 1, wherein said seat structure is fixed to said base to prevent movement of said seat structure in a horizontal plane.

4. The chair of claim 1, wherein said seat structure comprises a rigid support and a flange extending from said support, said flange being pivotally connected to said backrest structure.

5. The chair of claim 4, further comprising a pivot pin connected to said flange and said backrest structure for pivotally connecting said backrest structure to said seat structure.

6. The chair of claim 1, wherein said seat structure comprises a rigid support along at least a portion of a periphery of said seat structure and discrete sections of material situated between opposed sides of said support and defining a sitting surface of said seat structure.

7. The chair of claim 1, wherein said footrest structure comprises a substantially U-shaped member having first and second ends.

8. The chair of claim 7, further comprising first and second pivot pins for connecting said first and second ends of said U-shaped member of said footrest structure to said seat structure.

9. The chair of claim 7, wherein said footrest structure further comprises first and second elongate extensions fixedly connected to said first and second ends of said U-shaped member, respectively, said first and second extensions being pivotally connected to said front end of said transfer structure.

10. The chair of claim 9, further comprising first end second pivot pins for connecting said first and second extensions, respectively, to said front end of said transfer structure.

11. The chair of claim 1, further comprising armrests connected to said transfer structure.

12. The chair of claim 1, wherein said backrest structure comprises a rigid support along at least a portion of a periphery of said backrest structure and discrete sections of material situated between opposed sides of said support and defining a support surface of said backrest structure.

13. The chair of claim 1, wherein said transfer structure comprises a connecting member pivotally connected to said backrest structure and first and second arcuate member each pivotally connected at a forward end to said footrest structure and fixedly connected to said connecting member at a rearward end.

14. The chair of claim 13, wherein said backrest structure comprises a flange mounted on a back side, said connecting member being pivotally connected to said flange.

15. The chair of claim 1, wherein said base comprises a seat support structure connected to said seat and a plurality of tensioned legs each connected to said seat support structure whereby said legs flex upon vertical movement of said seat structure.

16. The chair of claim 15, wherein said tensioned legs comprise arched members each connected at a first end to said seat support structure and tension rods each connected at a first end to said seat support structure and at a second end to a second end of a respective one of said arched members.

17. A chair comprising:
a seat structure;
a base for supporting said seat structure without allowing movement in a horizontal plane;
a footrest structure pivotally connected to said seat structure such that a first pivot point is defined between said footrest structure and said seat structure;
a backrest structure pivotally connected at a lower end to said seat structure such that a second pivot point is defined between said backrest structure and said seat structure; and
a transfer structure pivotally connected at a front end to said footrest structure such that a third pivot point is defined between said transfer structure and said footrest structure and pivotally connected at a rear end to said backrest structure such that a fourth pivot point is defined between said transfer structure and said backrest structure;
whereby said first, second, third and fourth pivot point form a trapezoid which elongates upon reclining of the chair.

18. A chair comprising:
a base;
a seat structure supported on said base;
a footrest structure connected to said seat structure;
a backrest structure connected at a lower end to said seat structure; and
a transfer structure connected at a front end to said footrest structure and connected at a rear end to said backrest structure;
said base comprising a seat support structure connected to said seat and a plurality of tensioned legs each connected to said seat support structure whereby said legs flex upon vertical movement of said seat structure.

19. The chair of claim 18, wherein said tensioned legs comprise arched members each connected at a first end to said seat support structure and tension rods each connected at a first end to said seat support structure and at a second end to a second end of a respective one of said arched members.

20. The chair of claim 18, wherein said seat support structure comprises four braces having upper ends attached to said seat structure at a different location and lower ends connected together.
